(19) United States
(12) Patent Application Publication
(10) Pub. No.: US 2008/0226012 A1
(43) Pub. Date: Sep. 18, 2008

(54) Proliferation-Resistant Nuclear Reactor

(75) Inventors: Georgi V. Tsiklauri, Los Angeles, CA (US); Robert J. Talbert, Kennewick, WA (US); Alan E. Waltar, Peshastin, WA (US); Thomas E. Shea, West Richard, WA (US); Darrell F. Newman, Richland, WA (US); Winston W. Little Jr., Richland, WA (US)

Correspondence Address: BATTELLE MEMORIAL INSTITUTE;ATTN: IP SERVICES, K1-53, P. O. BOX 999, RICHLAND, WA, 99352, US

(73) Assignee: Battelle Memorial Institute

(21) Appl. No.: 11/996,872

(22) PCT Filed: Jul. 27, 2006
(86) PCT No.: PCT/US06/29412

§ 371 Date: Jan. 25, 2008

Related U.S. Application Data
(60) Provisional application No. 60/703,278, filed on Jul. 27, 2005.

(51) Int. Cl. G21C 1/07

(52) U.S. Cl. 376/305

(57) ABSTRACT

Proliferation-resistant nuclear reactors are disclosed according to some aspects. In one embodiment the proliferation-resistant nuclear reactor comprises a plurality of spherically-shaped micro-fuel elements (MFEs), each comprising a MFE core having one or more fuel kernels, a buffer external to the fuel kernels, and one or more coatings external to the MFE core providing corrosion resistance, erosion resistance, fission product containment, or a combination thereof. The MFEs are not suspended in a solid material and each MFE is sized such that its delay time is less than its accident time. The nuclear reactor further comprises a reactor core containing at least a portion of the plurality of MEs, wherein the reactor core is configured for cross-flow of a coolant.

### STATEMENT REGARDING FEDERALLY SPONSORED RESEARCH OR DEVELOPMENT

This invention was made with Government support under Contract DE-AC0576RLO1830 awarded by the U.S. Department of Energy. The Government has certain rights in the invention.

### BACKGROUND

Commercial reactors typically operate in developed countries having large electric power distribution systems and nuclear fuel cycle facilities. For example, many of the current commercial nuclear reactors are light water reactors (LWRs) for electricity production with power levels of approximately 1000 MWe or more. However, most developing countries do not have the need for large reactors, nor do they have the infrastructure and capacity to maintain such reactors. Of greater applicability can be relatively small nuclear power plants that can efficiently deliver electricity, heat, and ultimately, fresh water for the growing populations. The nuclear reactors that can be supplied to these countries also need to address international non-proliferation objectives and requirements. Accordingly, there is a need for nuclear reactors that can provide stable energy production without providing access to nuclear materials, or relevant nuclear technology, that might be used for nuclear weaponry.

### SUMMARY

At least some aspects of the present disclosure describe proliferation-resistant nuclear reactors. For example, in one embodiment, a proliferation-resistant nuclear reactor comprises a reactor core containing a plurality of spherically-shaped micro-fuel elements (MFEs), wherein the reactor core is configured for cross-flow of a coolant. Each of the MFEs comprise a MFE core having one or more fuel kernels, a buffer external to the fuel kernels, and one or more coatings external to the MFE core providing corrosion resistance, erosion resistance, fission product containment, or a combination thereof. The MFEs are not suspended in a solid material and each MFE is sized such that its delay time is less than its accident time.

One approach to maintaining short delay times is by appropriately sizing the MFEs. Specifically, the MFEs can be sized to promote rapid heat-transfer characteristics while retaining the ability to be physically moved (i.e., “flow”) and be constrained from fluidizing. Accordingly, in one embodiment, the MFEs have a diameter greater than or equal to approximately 1 mm and less than or equal to approximately 10 mm.

In one embodiment, metal-ceramic composite materials can be used for at least one of the one or more coatings providing corrosion and/or erosion resistance. Examples of metal-ceramic composites can include, but are not limited to nanolayered nitride hard coatings such as TiN, NbN, CrN, ZrN, and combinations thereof.

The fuel kernels can comprise a material having an element selected from the group consisting of uranium, thorium, plutonium, and combinations thereof. The material can be selected from the group consisting of oxides, nitrides, carbides, metals, and combinations thereof. Thus, for example, a fuel kernel can include, but is not limited to, UO₂, PuO₂, UC, mixed oxide fuels, and U-Th blends. Actinides and compounds thereof may also be present in the fuel kernel and/or the MFE core. In one embodiment, the fresh MFEs are less than approximately 20% enriched. In another embodiment, fresh MFEs comprise between approximately 8% and approximately 12% U²³⁵. In yet another embodiment, the MFEs can further comprise a burnable absorber, which can be implemented as a coating and/or be contained in the MFE core. The MFE core can comprise fuel kernels suspended in another material or, one kernel can comprise the entire core.

In one embodiment, the reactor core can comprise at least one constrained bed of the MFEs. In one version of the nuclear reactor, the reactor core comprises a concentric cylindrical structure. Such a structure can accommodate annuluses that alternately contain primarily MFEs or primarily coolant. Alternatively, it can accommodate a column of MFEs surrounded by coolant. The coolant can comprise water, gas, or liquid metal.

In another embodiment, the reactor core can comprise a plurality of reaction zones. The zones can contain MFEs having various states of fuel consumption, different fuel contents, and/or different burnable poisons. Furthermore, the residence time of the MFEs in each zone can be independently controlled. In one embodiment, the reactor core does not contain materials that readily react to produce hydrogen, for example, zirconium.

In some embodiments, the nuclear reactor comprises a pressure vessel containing not only the reactor core, but also a first volume for fresh micro fuel elements and/or a second volume for spent micro fuel elements. Alternatively, the fresh fuel and spent fuel volumes can be combined, with space for spent fuel provided as fresh fuel is transferred to the reactor core. The nuclear reactor can further comprise means for in-vessel refueling and/or fuel recycling, wherein spent MFEs are exchanged for fresh MFEs in the reactor core. In a specific embodiment, the in-vessel refueling and/or fuel recycling can occur on-load. In yet another embodiment, the nuclear reactor is permanently closed, thereby limiting access to the fuel during the lifetime of the reactor.

In one embodiment, gravity provides the means for in-vessel refueling and/or fuel recycling, which can be controlled with valves. For example, the first volume can be located above the reactor core, which can be above the second volume. The weight of the MFEs (i.e., “head pressure”) can urge MFEs to flow downward from the first volume to the reactor core and from the reactor core to the second volume.

The means for in-vessel refueling and/or fuel recycling can also comprise an actuator to facilitate movement of the MFEs through the pressure vessel. A function of the actuator can be to transfer MFEs from the first volume to the reactor core, from one reaction zone to another, and/or from the reactor core to the second volume. Additionally, the force provided by the actuator can be utilized to overcome other forces that oppose the desired movement of the MFEs including, but not limited to head pressure, gravity, flow constrictions, and friction. Examples of actuators can include, but are not limited to pistons, fluid jets and other hydraulic systems, engineered overlayers, and combinations thereof. Examples of engineered overlayers can include, but are not limited to non-reactive pellets or a slab of material.

Fluid jets can be used in place of, or in addition to, pistons and engineered overlayers to move the MFEs. In one example, a spring-loaded piston can be used in conjunction with fluid jets to control movement of the MFEs. The spring-loaded piston can constrain the packed bed during normal operation. Similarly, the weight of an engineered overlayer on top of the MFEs can constrain the packed beds. The fluid jets can fluidize the packed bed and allow the MFEs to flow with or against gravity, depending on the fluid flow rate.

In some embodiments, the nuclear reactor further comprises a spent-fuel discharge conduit. The conduit can be attached to the second volume, wherein said conduit allows for discharge of the spent MFEs after the end of the nuclear reactor's lifetime.

The nuclear reactor can be selected from the group consisting of boiling water reactors, pressurized water reactors, supercritical water reactors, high-temperature gas reactors, and liquid-metal-cooled reactors. The pressure vessel can be located below ground. In a specific embodiment, the pressure vessel is not housed within a containment building.

### DESCRIPTION OF DRAWINGS

Embodiments of the invention are described below with reference to the following accompanying drawings.

FIG. 1 is a schematic diagram of an embodiment of a proliferation-resistant nuclear reactor.

FIG. 2 is a schematic diagram of an embodiment of a proliferation-resistant nuclear reactor.

FIGS. 3a, 3b, and 3c are cross-section views of an embodiment of a reactor core.

FIG. 4 is a schematic diagram of an embodiment of a fresh fuel storage tank.

FIG. 5 is a schematic diagram of an embodiment of a reactor core.

FIG. 6 is a schematic diagram of an embodiment of a reactor core.

FIG. 7 is a schematic diagram of a telescoping control rod assembly.

FIG. 8 is a schematic diagram of a flow control device.

FIG. 9 is a cross-section view of an embodiment of a micro fuel element.

FIG. 10 is a schematic diagram of a fresh fuel canister.

FIG. 11 shows a spent fuel removal scheme.

FIG. 12 is a representation of an embodiment of a safety system.

FIG. 13 is a representation of an embodiment of a nuclear power plant utilizing a proliferation-resistant nuclear reactor.

### DETAILED DESCRIPTION

For a clear and concise understanding of the specification and claims, including the scope given to such terms, the following definitions are provided.

As used herein, permanently closed can refer to a nuclear reactor having a pressure vessel that is designed for continuous and enduring operation without marked disruptions during the operational lifetime of the reactor. Examples of marked disruptions can include, but are not limited to, opening the reactor for refueling, inspection, maintenance of reactor internal components, and retrieval of the MFEs. Closure can occur after initial MFE loading, after installation at a plant site, and/or any other time prior to bringing the nuclear reactor on-line. Thus, access to the internal components and/or fuel is significantly and physically limited from the time that the reactor is permanently closed until the vessel is opened in a destructive manner. An example of a permanent closure includes, but is not limited to, sealing of all access points by metal welds with the exception of ports required for operation of the reactor. Such ports do not provide reactor access, which might allow removal of MFEs, and can include, for instance, coolant ports, steam outlets, water inlets, and electrical and mechanical feeds.

The corrosion and/or erosion resistant coatings, as described herein, can refer to MFE coatings that prevent coolant from breaching the inner portions of an MFE. It typically refers to the outermost coating. In some instances, one coating can provide resistance to both corrosion and erosion. In other embodiments, the corrosion and/or erosion coatings can also provide chemical-attack protection and impact resistance.

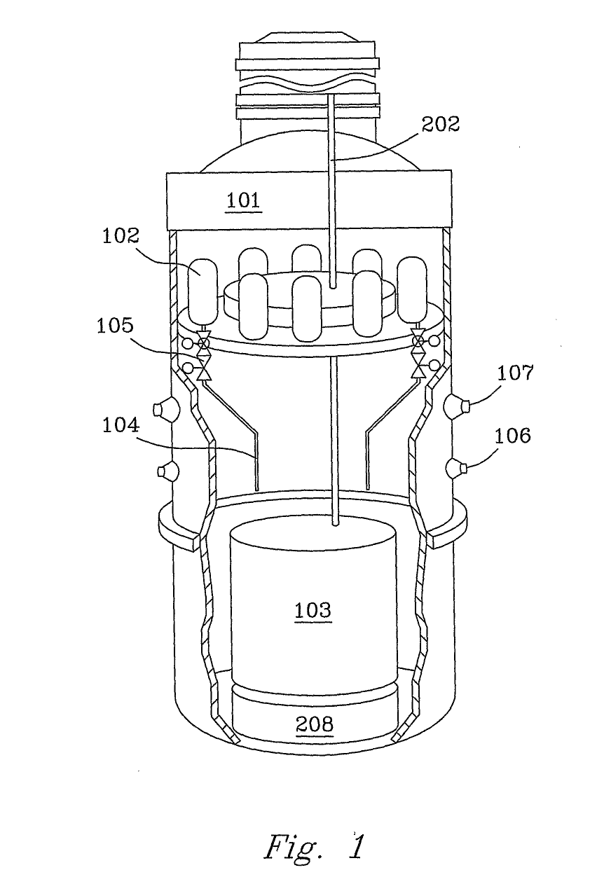

FIG. 1 is a schematic diagram of an embodiment of the proliferation-resistant nuclear reactor. The pressure vessel 101 comprises a storage volume for fresh MFEs 102, a reactor core 103, and a storage volume for spent MFEs 208. The fresh MFE storage volume 102 can comprise a plurality of individual containers, as depicted in FIG. 1, or it can comprise a single container, which can be partitioned. Alternatively, as described below, no physical separators or containers need to exist between the fresh MFEs, the spent MFEs, and the reactor core. As fuel is consumed in the reactor core 103, fresh fuel can be dispensed from the storage volume to the core through conduits 104. Similarly, the spent fuel in the core can be transferred to the spent-fuel volume for storage. The flow rate and frequency of refueling can be controlled by valves 105.

For vessels oriented vertically, as in the present embodiment, flow of the MFEs can be driven substantially by gravity. The reactor can further comprise vertical control rods 202 that enter from the top of the vessel. The nuclear reactor is permanently closed and the only openings in the vessel are ports required for exchange of coolant and, optionally, steam (106 and 107).

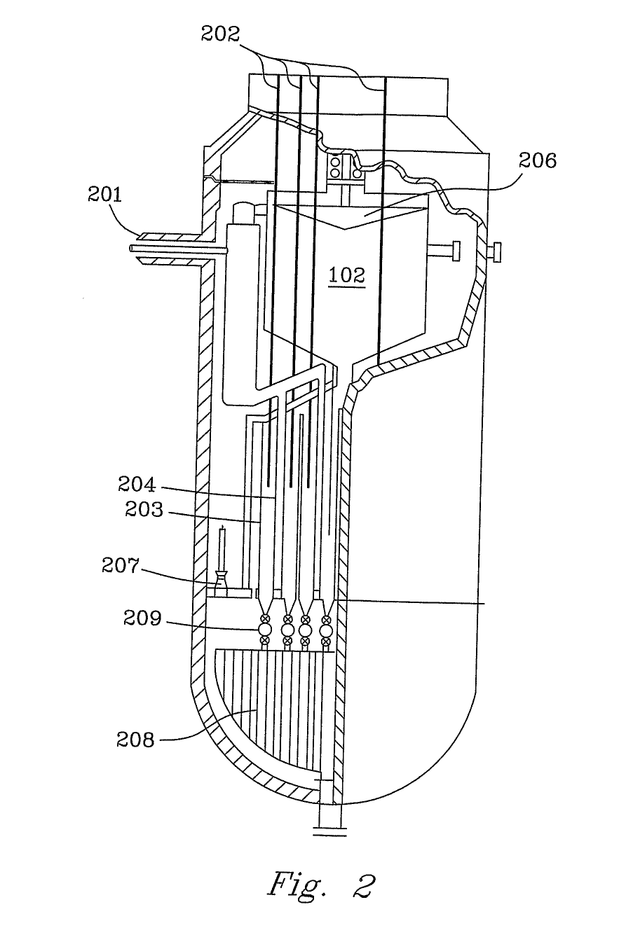

A variant of the proliferation-resistant nuclear reactor can have a reactor core comprising constrained beds of the MFEs arranged in a concentric cylindrical structure. Referring to FIG. 2, coolant can enter from an annular nozzle 201 located in the upper portion of the pressure vessel. The coolant flows around the vessel and downward between the reactor core and vessel. Internal circulation can be provided by any means including, but not limited to hydraulic pumps. Jet pumps 207 can be preferable because they have no moving parts. A spring-loaded upper plate, or piston, 206 can constrain the MFEs from fluidizing in the reactor core.

The piston 206 can also serve as an actuator, providing at least a portion of the motive force for moving the MFEs, as described elsewhere herein. For example, in embodiments having a fresh fuel storage volume 102 and/or a spent fuel storage volume 208, the actuator can participate in moving MFEs from the fresh fuel storage volume 102 to the MFE beds in the reactor core and/or from the reactor core to the spent fuel storage volume 208. An intermediate discharge volume 209 can be used to measure out an appropriate amount of spent fuel to be discharged. In one embodiment, the fresh fuel and/or spent fuel storage volume can also include a neutron poison. One example of such a neutron poison includes borated steel pipes and/or plates.

Control rods 202 and their drives are inserted from the top. The rods can normally be partially inserted inside the core during full-power operation. Perforated coolant inlets 203 and perforated vents 204 in the annular channels constrain the MFEs while allowing coolant to pass through the reactor core.

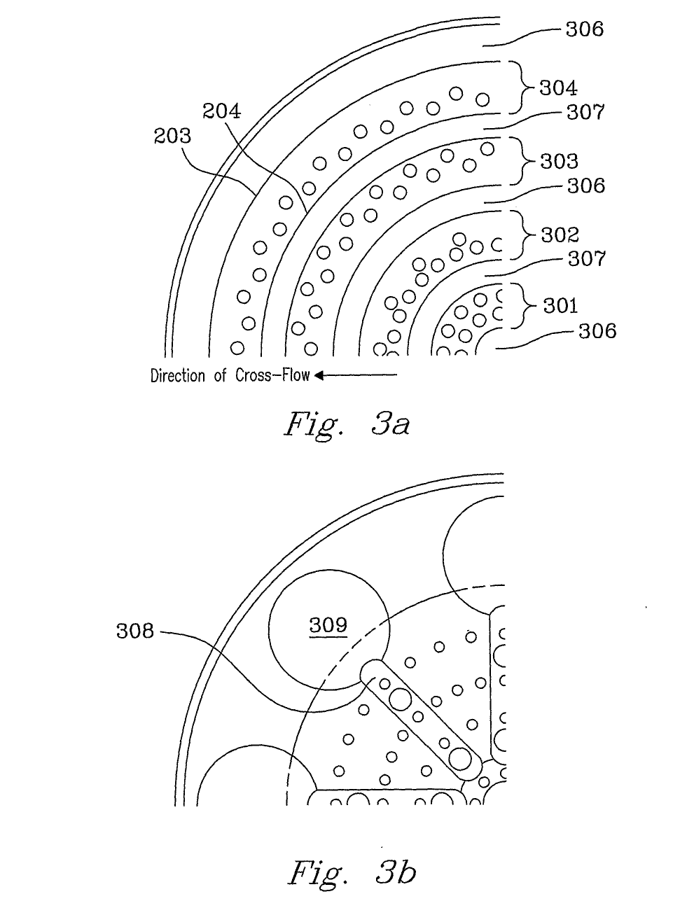

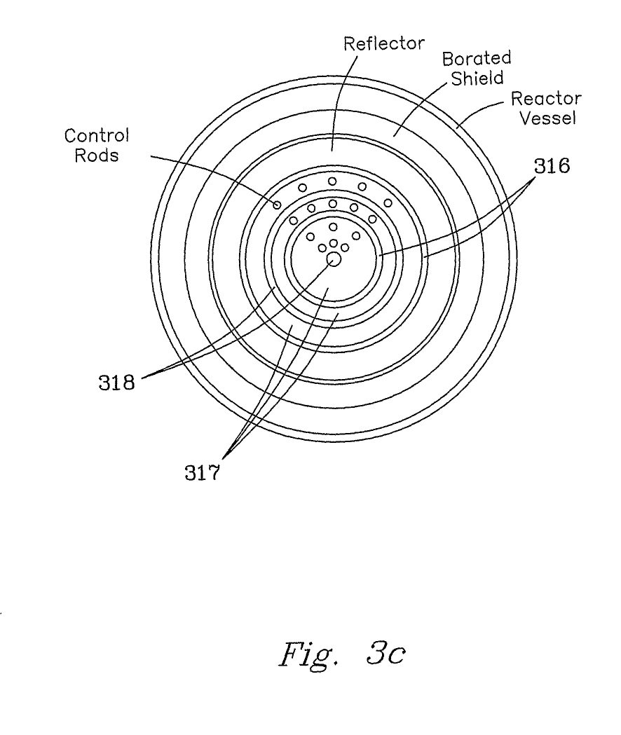

In one embodiment, referring to FIG. 3a, the reactor core is divided into four concentric cylindrical zones 301-304 containing the packed beds of MFEs. Embodiments of the present invention encompass any number of reaction zones. Each zone can contain MFEs having a different amount of fuel consumption, a different fuel content, a different amount of moderator, a different coolant flow rate, and/or a different burnable poison. The residence time of the MFEs in each zone can be separately controlled. Furthermore, MFEs from one zone can be recycled into another zone to maximize the fuel usage. The actuator for moving fuel for refueling can also be used for recycling, as described below. Vertical tubes serve as control rod shrouds and penetrate the MFE beds throughout the core. The tubes can comprise boron (e.g., borated stainless steel).

Coolant can flow upward to the core and in a substantially cross-flow direction through the MFE beds. The upward flow can come from a bottom plenum into annular channels 306 having perforated walls. The coolant then travels through the perforations 203 and enters the various packed beds 301-304. The coolant cools the MFEs in the packed beds and moves in a cross flow toward and through perforated vents 204 that lead to outlet channels 307. The temperature profile of the coolant flow along the height of the core can be altered by tuning the wall perforations.

Referring to the embodiment depicted in FIG. 3b, in which the coolant is water, steam can be collected in an upper steam header 308 and can leave the core to steam separators 309. The bottom of the steam collectors can have a filter to remove particulates from the liquid water. To compensate for a decrease in coolant density due to boiling, the packed MFE beds close to the steam vents can further include water pipes 205 with slow moving water, for example, water flow that is almost stagnant.

Alternatively, for embodiments in which the coolant is a gas, hot gas can leave the reactor core and flow to one or more steam generators. Referring to the embodiment depicted in FIG. 3c, hot gas can enter gas channels and be collected in an upper hot gas header. For example, annular reactor cores can be configured such that reaction zones 317 are located between cold gas channels 318 and hot gas channels. Hot gas can leave through perforated vents to enter hot gas channels and be collected in an upper gas header 316. The header can direct the hot gas to steam generators.

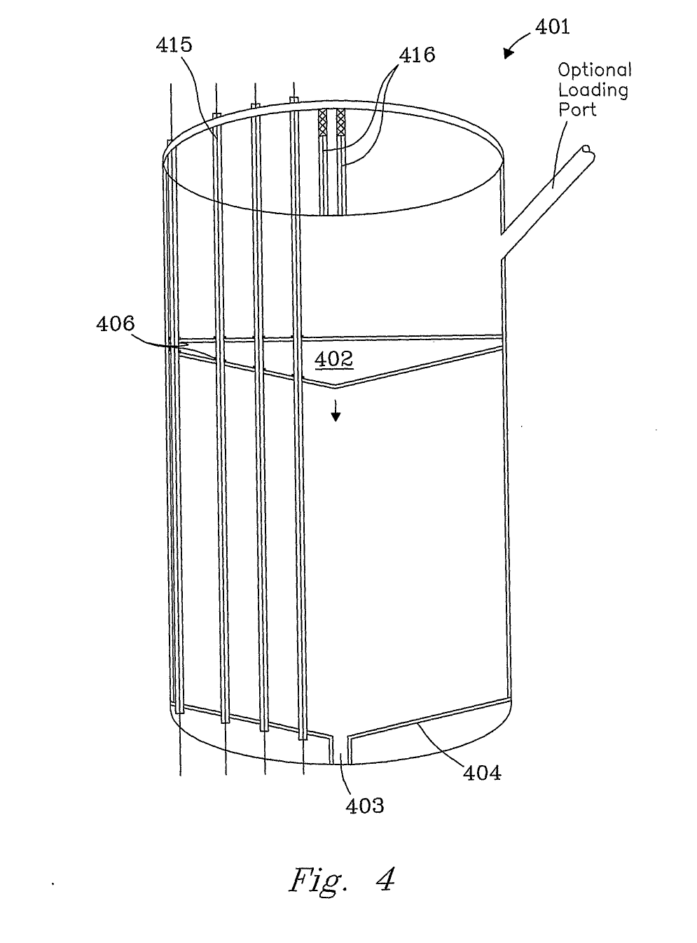

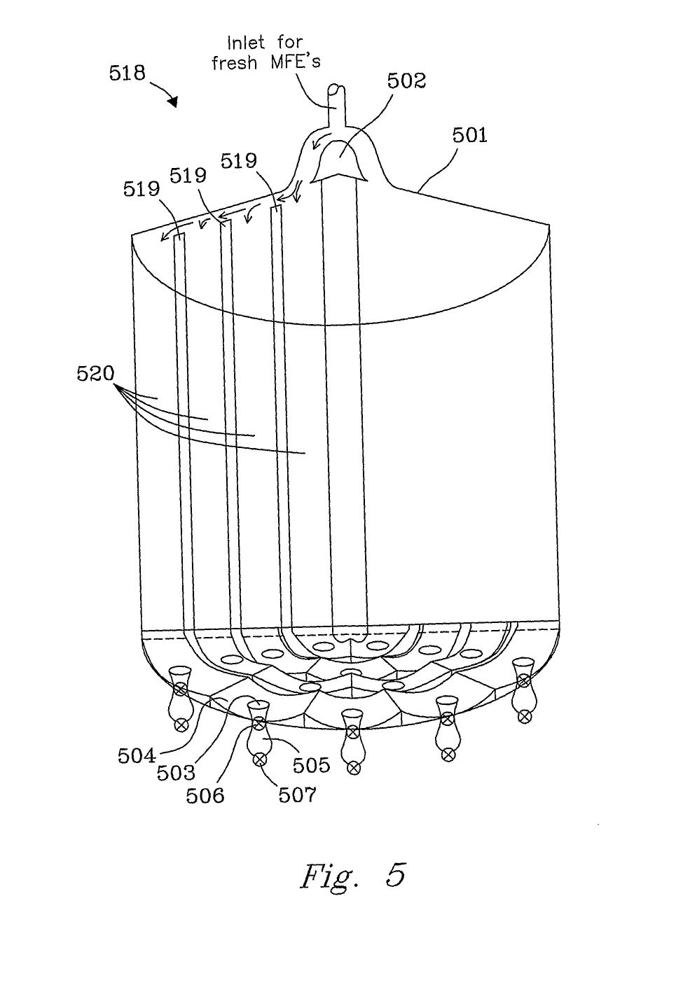

In some embodiments, internal refueling embodiment can be implemented by transferring spent fuel from the reactor core to the spent fuel storage volume and fresh fuel from the fresh fuel storage volume to the reactor core. Similarly, internal recycling can be implemented by transferring MFEs from one zone to another within the reactor core. For example, MFEs in the outer annular zones can be moved inward prior to being discharged into the spent fuel storage volume. In some variants, MFEs are recycled with assistance provided by a hydraulic force. Embodiments of the fresh fuel storage volume and the reactor core are shown schematically in FIGS. 4 and 5, respectively.

Referring to FIG. 4, the fresh fuel storage volume comprises a tank 401 and an actuator, which in the present embodiment comprises a conical sliding piston 402. In general, the piston can prevent the MFEs from fluidizing as a result of any upward fluid flow in the vessel. Another actuator, such as a fluid jet, can facilitate MFE movement for refueling and fuel recycling. The piston can be driven hydraulically and/or mechanically by, for example, springs and/or telescoping magnetic drives 416. Sliding seals 406 around the periphery of the piston 402 and around the control rods 415, which pass through the piston, allow the piston to travel vertically as fuel is emptied. Alternatives to the piston include, but are not limited to engineered overlayers and fluid jets. As used herein, an engineered overlayer can refer to a monolithic piece of material or to loose particles such as stainless steel pellets. Fresh MFEs leave the fresh fuel storage tank 401 through a refueling funnel 403 located in the conical tank bottom 404.

The embodiment of the reactor core 518 shown in FIG. 5. comprises a conical upper lid 501, and a dome cap 502 over a center column of coolant. The walls 519 of the outer coolant channels are progressively lower in height than those of the inner channels. As MFEs from the fresh fuel storage tank fall into the reactor core, they first fill the inner annular channels 520 and overflow into each outer channel 520. Discharge funnels 503 are located in the core, under each packed MFE bed annulus. Conical or parabolic shaped false-bottoms 504 direct spent MFEs toward the nearest discharge funnel. A discharge volume 505 can be placed between two valves and can empty a predetermined increment of spent MFEs, which loads a like amount of fresh MFEs. After closing the valve 506 between the funnel and discharge volume, the lower valve 507 is opened to empty the spent MFEs into the spent fuel storage volume below the reactor vessel. The valves can be operated remotely and, therefore, do not require manual handling of fuel by plant personnel. In one embodiment, the outer packed MFE bed annulus has 10 discharge funnels. The successive three inner annuli have eight, six, and four funnels, respectively. Each funnel is attached to a 20 l discharge volume, which is filled with spent MFEs by gravity and/or the actuator.

In one embodiment incorporating fuel recycling, only the outer annular zone receives fresh MFEs. Spent MFEs are discharged only through the innermost annular zone. MFEs from the outer zones can be moved inward, thereby recycling the fuel from the previous zone. For example, fresh MFEs can be loaded into the top of the outer zone as described previously. Partially reacted MFEs at the bottom of the outer zone can be moved inward to the top of the next zone using fluid jets. This can be repeated in each zone until the MFEs are spent and discharged through a valve at the bottom of the innermost zone.

The reactivity of the fresh fuel can be compensated by control rods and/or be augmented with a burnable absorber. To maintain uniform burnup of the fuel at each axial level in the core, the volume of spent fuel discharged periodically from each of the four annular zones of the core can be matched to the radial power distribution. Self-powered rhodium detectors can be located in a portion of the coolant-moderator tubes that penetrate the packed MFE bed annuli vertically. These detectors provide radial and axial power density information, and the basis for selecting which spent fuel discharge volumes should be filled, and when. This can allow the MFEs to be discharged only after reaching their exposure goal, thereby maximizing the reactor's lifetime. Criticality safety can be maintained in both the fresh fuel and spent fuel storage volumes by including neutron absorbers, examples of which include, but are not limited to boron-stainless steel tubes and/or plates. Spent fuel radioactive decay heat can be removed passively by conduction and natural convection with coolant in the lower plenum of the reactor vessel through the storage volume walls, and/or through the coolant pipes.

Embodiments of proliferation-resistant nuclear reactors, as described elsewhere herein, can be scaled to provide almost any level of power production for a particular lifetime. For example, in the examples described below, the reactors are designed for an approximately 60 year lifetime and a capacity of approximately 100-160 MWe. However, if shorter lifetimes are desired and/or acceptable, the same reactor can be scaled to produce 1600 MWe operating for 6.1 years.

One non-limiting example is a water-cooled nuclear reactor having a lifetime of 60 years and a capacity of approximately 100 MWe. The reactor components can be made of ferritic/martensitic stainless steels.

The estimated parameters for such a reactor are summarized in Table 1 below.

TABLE 1
Exemplary design parameters for an embodiment
of a water-cooled nuclear reactor having a capacity
of 100 MWe and a lifetime of 60 years.
General Parameters of the Plant

| | |
|---|---|
| Electric Power, MWe | 100 |
| Thermal Power, MWt | 300 |
| Type of Reactor | BWR |

Coolant
Boiling Water

| | |
|---|---|
| Feed Water Pressure, MPa | 7.5 |
| Steam Pressure, MPa | 7.2 |
| Inlet Temperature, ° C. | 270 |
| Outlet Temperature, ° C. | 291 |
| Coolant Flow Direction | Cross-Flow |

Reactor Core Parameters

| | |
|---|---|
| Core Inner Diameter, m | 3.1 |
| Core Height, m | 3.0 |
| Core Volume, m³ | 25.6 |
| Fuel Bearing Core Volume, m³ | 12.8 |
| Packed MFE Bed Porosity | 0.35 |
| MFE Density, g/cm³ | 5.775 |
| Mass of MFE in the Core, Mt | 48 |
| Mass of UO₂ in the Core, Mt | 33 |
| Mass of UO₂ in Fresh Fuel | 40 |
| Storage, Mt | |
| Mass of U²³⁵ (Core + Fresh Fuel | 7.3 |
| Storage), Mt | |
| Enrichment, % | 10 |
| Spent Fuel Burnup Exposure, | 100 |
| GW d/Mt (for steady-state core) | |
| Average Core Power Density, | 13.25 |
| MW/m³ | |
| Core Fuel Residence Time, Day | 20,836 |
| Years | 60 |

Annular Core

4 Reaction zones
3 Water Inlet Headers
2 Steam Headers

Fuel
Small Spherical Particles- MFE

| | |
|---|---|
| Diameter of MFE, mm | 2 |
| Diameter of UO₂ kernel, mm | 1.5 |

Reactor Vessel
Cylindrical Shell

| | |
|---|---|
| Inner Diameter, m | 5 |
| Vessel Height, m | 13 |

Another non-limiting example of a proliferation-resistant nuclear reactor is a high-temperature gas cooled nuclear reactor having a lifetime of approximately 61 years and a capacity of approximately 160 MWe. While one set of estimated parameters for such a reactor are summarized in Table 2 below, other parameters and configurations are possible. For instance, regarding MFE composition, the MFEs can comprise low-enriched uranium (LEU) containing less than approximately 20% of U-235 and/or U-233. Alternatively, Pu containing greater than or equal to approximately 6% Pu-238, which is proliferation resistant, could also be used.

TABLE 2
Exemplary design parameters for an embodiment
of a gas-cooled nuclear reactor having a capacity
of 160 MWe and a lifetime of 60 years.

| SYSTEM PARAMETERS | VALUE |
|---|---|
| Electric Power, MWe | 160 |
| Thermal Power, MWt | 350 |
| Type of Reactor | HTGR |
| Efficiency | 45% |
| Coolant | He |
| Coolant pressure, MPa | 10 |
| Outlet Coolant Temperature, ° C. | 850 |
| Inlet Coolant Temperature, ° C. | 450 |
| Nominal Flow, kg/s | 135 |
| Fuel Bed Porosity | 0.35 |
| Core Diameter, m | 3.4 |
| Core Height, m | 3.3-3.5 |
| Inner Vessel Diameter, m | 5-5.5 |
| Average Power Density, MWt/m3 | ~20.0 |
| In core MOX mass inventory, MT | 43 |
| Discharge burnup, GW d/MT | 160 GW d/MT |
| Breeding ratio | 0.8 |
| Core Fuel Residence Time, Day | 20,000 |
| Years | 60.8 |
| Fuel Composition | MOX |
| PuO₂ | 14% |
| UO₂ | 86% |
| Discharged Isotopic Content | wt 26% Pu240; wt 4.5% Pu241 |
| Secondary Cycle: Supercritical Pressure | |
| Rankine Cycle | |
| Steam Pressure, MPa | 24 |
| Steam Temperature, C. | 600 |

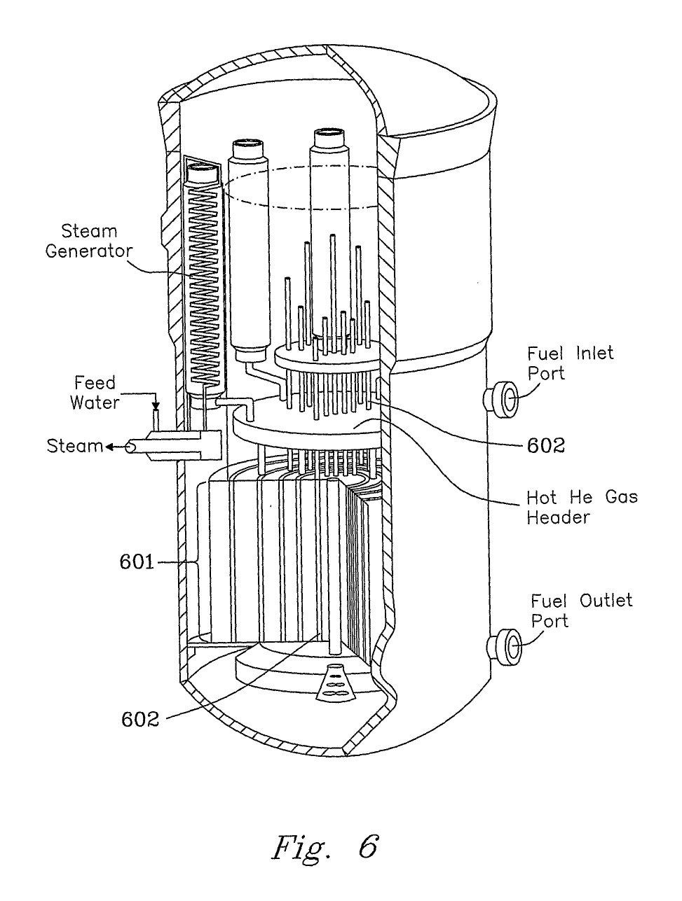

FIG. 6 schematically shows an embodiment of the nuclear reactor wherein the fresh fuel storage volume, the reactor core, and the spent fuel storage volume are not separated by physical walls and/or tanks. Instead, the entire inventory of MFEs is contained in a column 601 and the reactor comprises a plurality of telescoping control rods 602. The packed MFE bed column remains stationary and no fuel movement or transfer is required.

Referring to FIG. 6, at the beginning of the reactor life, all the control rods are nearly fully extended into the fuel column, as necessary, to maintain constant power. As the MFEs near the lower section of the core burn and lose reactivity, the control rods are progressively withdrawn to maintain the power level. Control rods near the periphery of the fuel column can be preferentially used to maintain reactivity and flatten the radial power distribution. The axial power distribution peak progressively moves upward as the control rods are raised to compensate for reactivity loss due to the fuel burnup in lower parts of the column. At the end of the reactor lifetime, the control rods will be fully withdrawn and the entire column will comprise spent MFEs. Accordingly, the storage volumes and reactor core comprise zones rather than tanks.

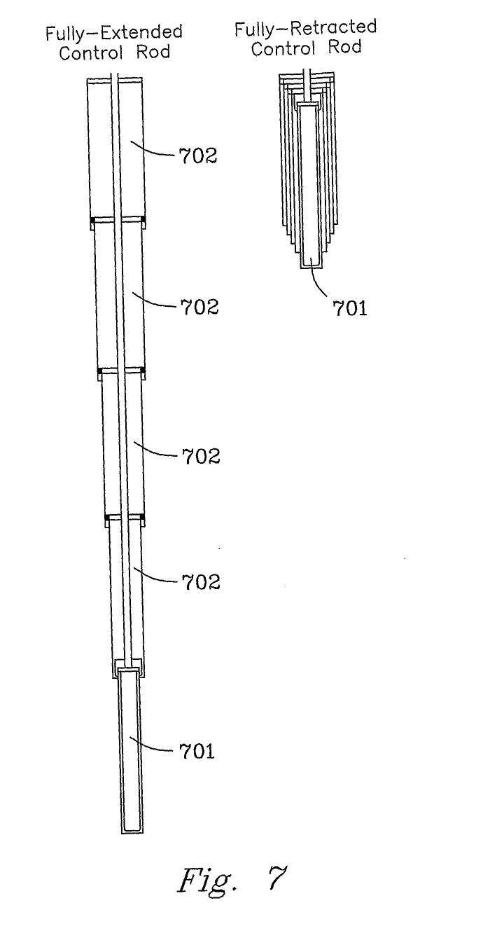

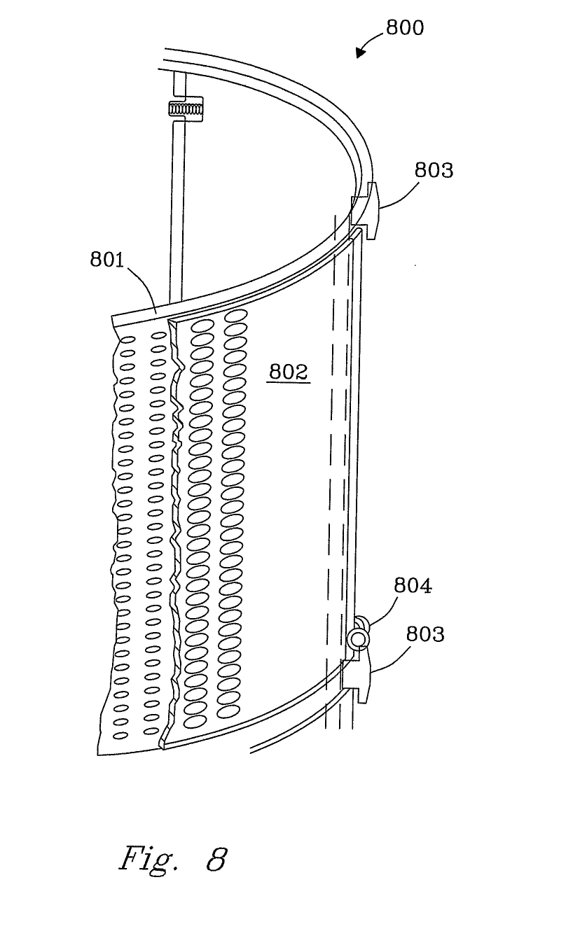

In one embodiment, referring to FIG. 7, the lower section of the telescoping control rods can contain B₄C pellets 701, while the remaining sections can comprise nested sleeves of boron-stainless steel 702. While FIGS. 6 and 7 show a vertically-oriented vessel with downward extending control rods, the instant embodiment is not limited by orientation. Thus, the control rods can extend upward in a vertical reactor or sideways in a horizontal reactor.

In order to minimize differences in axial power density, the coolant flow rate can be matched to the axial power density. Accordingly, a coolant flow control device 800 can be used as shown schematically in FIG. 8. The device can comprise a stationary inner nozzle sheet 801, a rotating outer nozzle sheet 802, a stationary track 803 to guide the rotation of the outer sheet, and a worn gear 804 to rotate the outer sleeve. The sleeves surround the coolant annuli and have a predetermined height. In one embodiment, the perforations in the inner and outer sheets differ in size, number, or both. When the perforations are maximally aligned, a maximum flow is provided. The flow rate decreases when the outer sheet is rotated to any position other than the maximally aligned position. Thus, the proper coolant flow rate can be delivered in each axial section. As fuel burnup progresses and the axial peak moves upward, the coolant flow rate can be adjusted to coincide with the heat generation rates.

Fuel particles for some gas-cooled reactors are detailed in U.S. Pat. Nos. 4,022,660; 4,035,452; 4,116,160; 4,267,019; and 4,963,758; which details are incorporated herein by reference. However, the MFEs encompassed by embodiments of the present invention are separate particles in that they are not suspended in a solid material or matrix, as might be found in traditional pebble bed and prismatic reactor designs. They have strong negative coolant and void reactivity coefficients with a short thermal delay time, which is less than the accident time. As used herein, the accident time can refer to the time for developing severe consequences, including, but not limited to, fuel failure in the reactor core. Furthermore, they have a large heat transfer surface area, minimizing the likelihood of core melting.

In one embodiment, the thermal delay time of an MFE is at least ten times shorter in duration than its accident time. This can allow the reactor to shut down automatically without any involvement from plant personnel. The delay time can be affected, in part, by the size of the MFEs. Specifically, the delay time, t_{delay}, can be expressed as a function of the radius of the MFE, as described by Eqn. 1, wherein r is the radius of the MFE, C is specific heat capacity, ρ is the density, and λ is the coefficient of thermal conductivity.

$${t}_{delay} \approx \frac{{r}^{2} C ρ}{λ}$$

Since typical accident times can be a second or more, according to the instant embodiment, MFEs should be sized to give delay times of approximately 0.1 s or more. Table 3 summarizes the delay times for a number of MFE sizes of an exemplary MFE comprising a UO₂ MFE core and one 100 μm SiC coating. MFEs having different compositions and structures would have varying delay times, but still fall within the scope of the present invention.

TABLE 3
Exemplary delay times for various MFE particle
sizes. In the example, the MFE comprises a MFE
core of UO₂ and a 100 μm SiC coating.

| MFE Particle Radius (mm) | Delay Time (sec) |
|---|---|
| 1 | 0.05 |
| 2 | 0.2 |
| 3 | 0.5 |
| 10 | 5 |

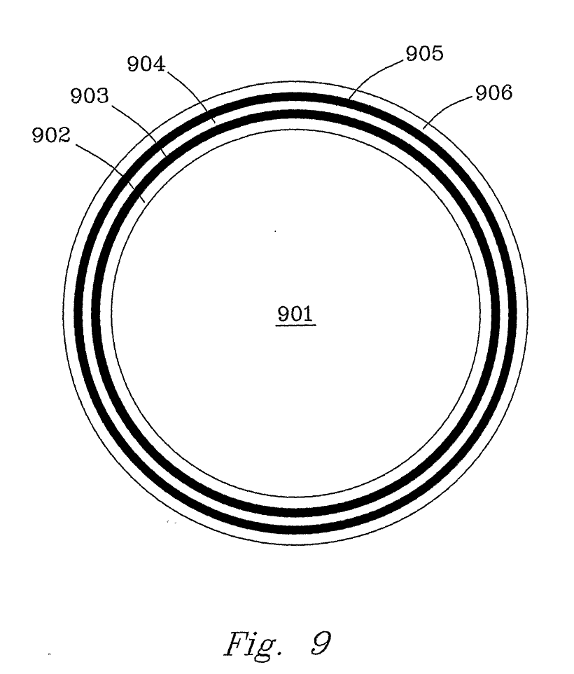

FIG. 9 is a cross-sectional view of an embodiment of the MFE, which has a core comprising UO₂ 901. Alternatively, the core could comprise a plurality of fuel kernels suspended in another material. In the present embodiment, the buffer layer 902 comprises a 100 μm thick porous pyrocarbon coating. The buffer layer can serve to attenuate fission product recoil, to control pressure in the MFE particle by providing a free volume for gas generation and expansion, and to accommodate core swelling. The buffer layer can comprise a compressible material. A high-density carbon layer 903 can exist on the buffer coating to provide a smooth surface for subsequent coatings. It can also protect the core from chemicals liberated during subsequent coating processes, for example, chlorine migration associated with SiC deposition. In the instant embodiment, the SiC coating 904 serves as the primary barrier for retention of fission products and other gases. It is a containment coating that can also provides structural support to accommodate internal gas pressure. However, the containment coating is not limited to SiC, and other materials such as metals and nanostructured ceramics are encompassed by the scope of the present invention. Furthermore, additional layers can be added for enhanced containment robustness. Other embodiments can the MFE can include more, less, and/or alternative core materials and coatings.

Referring to embodiment illustrated in FIG. 9, the outermost pyrocarbon layer 905 can provide a bonding surface for a corrosion/erosion-resistant coating, which can also act as an additional barrier to both the release of internal gases and diffusion of external chemicals. The corrosion/erosion-resistant coating 906 in the instant embodiment comprises NbN, however, other metal ceramic materials are encompassed by other embodiments. Generally, a corrosion/erosion-resistant coating can serve as a cladding for the MFE and help protect the MFE from erosion, corrosion, acid attack, and against impact-damage. It can help prevent coolant from breaching the inner layers and the MFE core.

In some embodiments, the corrosion/erosion-resistant coating can be superhard, having a hardness greater than or equal to approximately 10 GPa. Since superhard materials may be brittle, a metal coating can be used for robustness, while providing an extra measure of proliferation resistance. Metal coatings can be more ductile and would resist cracking under extreme pressure and/or impact. Examples of suitable metals can include, but are not limited to Ti and/or Ni.

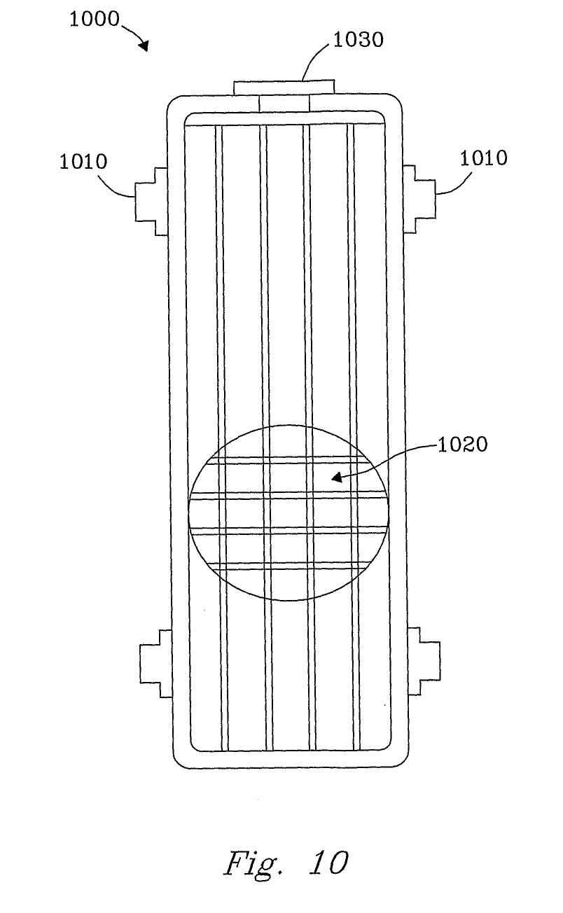

MFEs can be stored and shipped in shipping casks. The casks, which can be loaded with either fresh or spent fuel, can be limited to less than 25 MT to facilitate transportation. An embodiment of a fresh fuel canister is shown in FIG. 10. It has a 1.2 m OD and is 4.45 m long. It has a pair of lifting trunnions 1010 near each end to facilitate handling and lifting the loaded weight of the canister 1000. The interior of the 50 mm-thick wall canister has a borated stainless steel grid basket 1020 to provide criticality safety of the package containing the fresh MFEs. The canister can have an unloading fixture 1030 that replaces the lid used in transportation, which uses water to assist in charging fresh fuel into the reactor as a slurry, prior to sealing the reactor vessel.

The spent fuel canisters might have a smaller capacity than the fresh fuel canisters contain, because they must be loaded into heavily-shielded transportation casks.

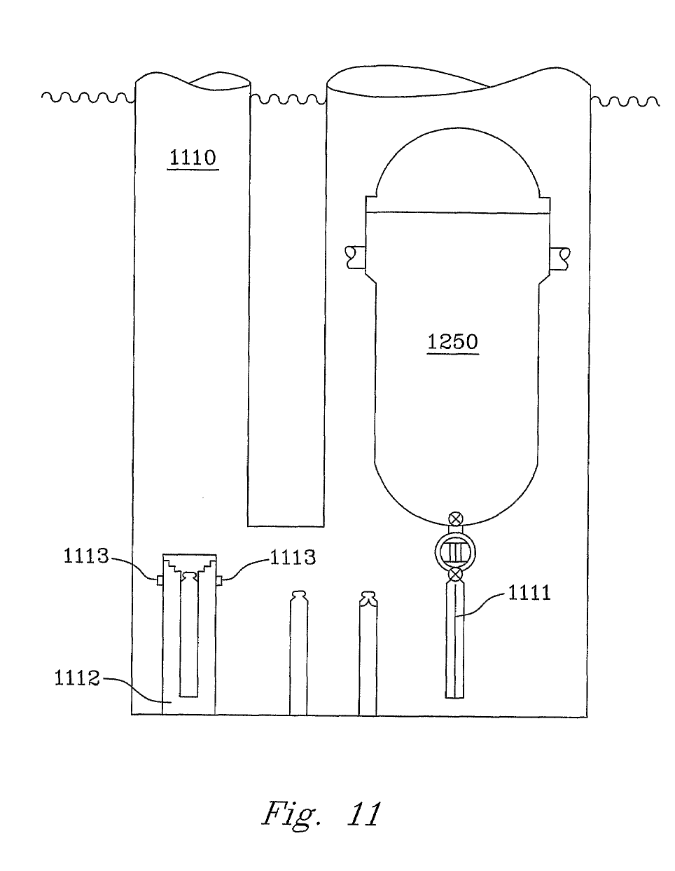

In one embodiment, the spent fuel canisters are 0.45 m OD and 4.4 m long, containing approximately 2.5 MT of spent MFEs. The canisters can be loaded in a drywell 1110 below the reactor vessel 1250, as shown in FIG. 11. A criticality-safe vessel 1111 receives a volume of spent fuel that will fill one spent fuel canister by use of hydraulically-operated disk valves (operated remotely). The spent fuel canisters can have a perforated false bottom that allows water in the MFE slurry to drain from the bottom of the canister to a waste-water treatment facility. Remote operations conclude with emplacement of the decontaminated canister into a spent fuel shipping cask 1112, such as the existing FSV-1 legal-weight truck cask and bolting on the shielded lid. Handling trunnions 1113 attached to the cask, assist in lifting the loaded cask out of the drywell, beside the reactor, and transporting it to the truck, and eventually onto the cargo aircraft, train, or ship. The entire spent fuel inventory can be removed in the spent fuel canisters, following the shutdown of the reactor after its lifetime. For criticality safety, the spent fuel canisters have an internal borated stainless steel cruciform which is adequate even for fresh fuel.

The reactor safety system can be completely passive. Since embodiments of the present invention utilize cross-flow in the core, axial core power is not dependent on the fluid enthalpy (density) gradient. Control rods entering from the top of the core are not used for axial core power distribution shaping, but rather for reactivity control and emergency shutdown control. As such, the safety systems of the present invention can be designed similar to those for conventional pressurized water reactors. The reactor vessel needs no penetrations below the reactor vessel steam and feed nozzles, which can be significantly above the top of the reactor core. Hence, no postulated line break will be below core height, and core flooding can be utilized. Further, control systems can be designed such that the power level of the core can be reduced by ˜20% during upset conditions that would cause a power increase, such as a cold water addition.

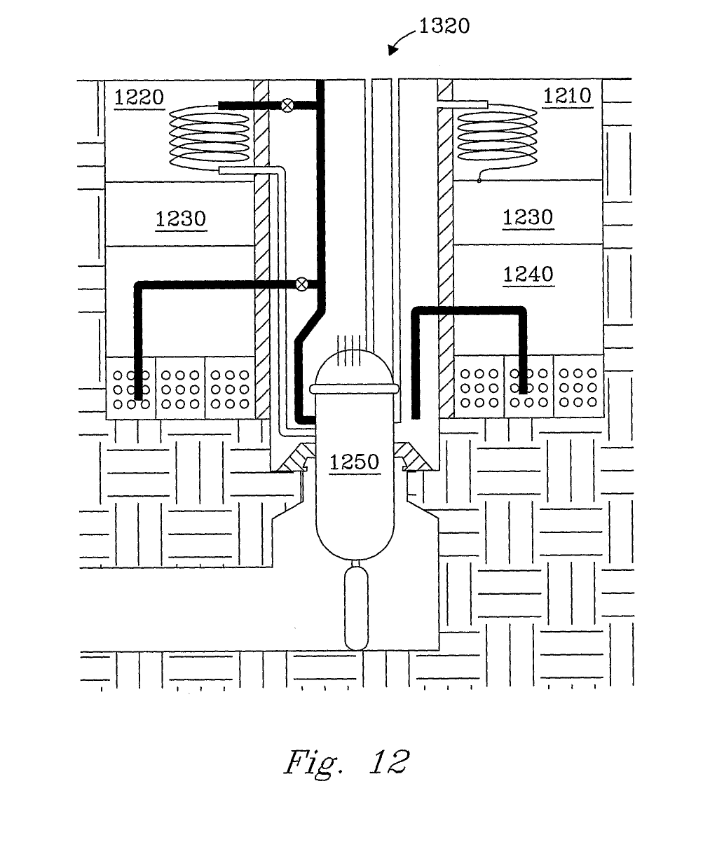

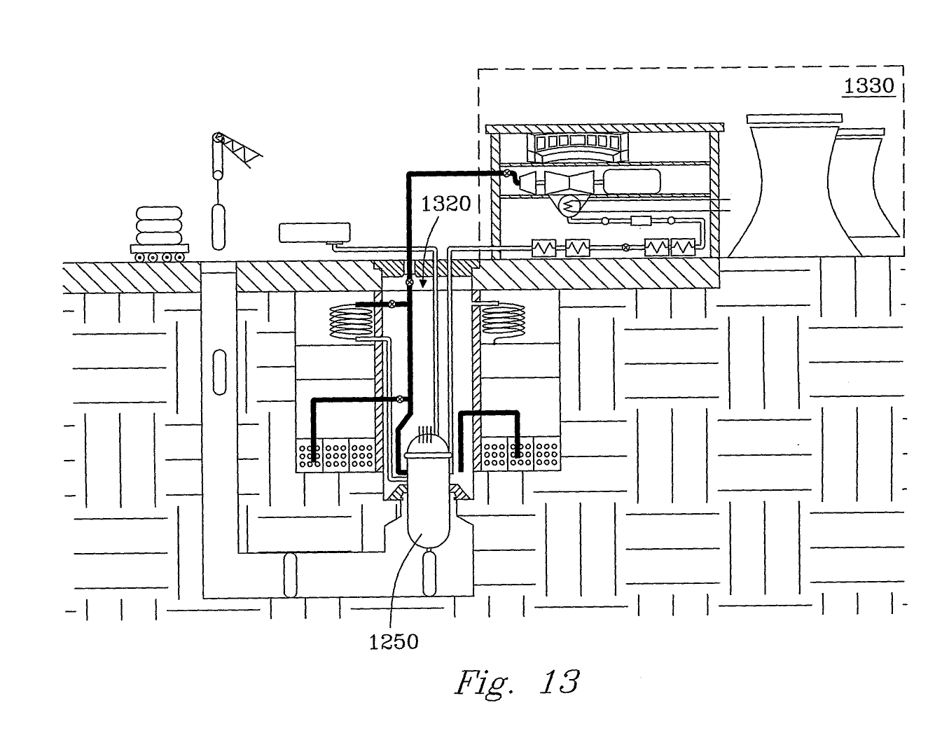

In one embodiment, the passive safety systems 1320 can comprise three annular tanks situated above the reactor vessel, substantially on top of one another. The systems involved in these three tanks include a passive containment cooling system 1210, a reactor isolation condenser 1220, core flood tanks 1230, and suppression chamber tanks 1240. Each tank can be divided into a plurality of separate compartments to inhibit wave action. The present embodiment shows eight compartments. The top tank can house the passive containment cooling systems and the isolation condenser systems. The middle level annular tank can be the core flood tanks. The lower level annular tank can be the suppression chamber tanks. All tanks would be beneath ground level. However, the top level tanks can be above grade. The bottom of the suppression chamber tank can be above the level of the reactor feed line nozzles, and hence, significantly above the top of the reactor core. These tanks are sized based upon the primary coolant inventory inside the drywell during normal operation and on reactor full power. FIG. 12 depicts the general arrangement of the passive safety systems. FIG. 13 shows the position of the reactor 1250 relative to the safety systems 1320 and the power plant components 1330. As shown, no containment building is required over the reactor, which is placed below ground.

In one embodiment, the eight sections of the containment cooling/isolation condenser annular tanks contain 4 containment cooling condensers and 4 isolation condensers, alternating for each tank section. The sections can be hydraulically connected to one another through ports in the section walls, effectively doubling the water volume and cooling capacity during either an isolation event or a loss of cooling event. These tanks can contain mechanical filling devices to replenish water that may have evaporated during operation. The tank air volume can vent to atmosphere through HEPA filters.

In this embodiment, the isolation condensers can comprise a condenser sitting in a water pool. Piping connects the isolation condenser to the main steam line. A condensate line from the isolation condenser connects to the reactor vessel feedwater line and is isolated by two check valves in series. The check valves can be held shut by the core delta pressure during normal operations. When an event occurs that requires reactor isolation, such as a steam or feed line break outside the confinement, the reactor main steam lines isolate. Steam from the isolated reactor can rise up into the isolation condenser, transfer heat to the pool on the condenser's secondary side and condense in the process. The condensate from the process returns to the reactor feedwater line by gravity. The total mass of fluid in the isolated reactor remains constant. Natural circulation drives the system. No pumps are involved.

According to the instant embodiment, passive containment cooling can be accomplished by a similar system. Confinement coolers are very similar to isolation condensers, but are designed for much lower pressures. Should a loss of coolant event occur, steam from the upper area of the drywell enters the confinement coolers, is condensed, and the condensate flows by gravity to the next series of tanks below, which can be the core flood tanks.

In this embodiment, each section of the upper tank can be cooled by naturally circulating air. An air intake enters the lower portion of each tank section, runs through a series of horizontal coils and exits the top of the tank. Effectively, in both LOCA and isolation events, the eventual sink for decay heat removal can be the atmosphere. Initially, the decay heat energy becomes absorbed by the volume of water in the upper tanks. After a period of time, the water becomes cooled by the natural convection of the air cooling system in each tank section. If the installation is placed in a warm climate, a swamp cooler evaporative design can be implemented to augment the cooling of these tanks.

In this embodiment, the middle set of tanks in this vertical arrangement can be made up of 8 core flood tanks. The core flood tanks are isolated from the reactor by sets of 2 check valves in series. The check valves can be gravity biased to be open when no differential pressure exists. The check valve on the reactor side of the piping contains a small hole such that the pressure between the two check valves remains at reactor pressure. The tank atmosphere vents to the drywell. When the reactor pressure decreases to near drywell pressure, the check valves open and water from the core flood tanks drain by gravity into the reactor vessel feedwater line. Post LOCA, the tanks can receive water from the condensate formed from the containment cooler condensers, maintaining the mass balance of water constant inside the control volume defined by the reactor, the drywell, and the extensions of the drywell (i.e., core flood tanks, suppression chambers, and the isolation condensers and containment cooling condensers).

In this embodiment, the lower set of tanks in this vertical arrangement are simple suppression chambers that have been used previously in BWRs. Each of the 8 sections possess two downcomers from the drywell with spargers to dissipate the steam and distribute the non-condensable gasses into the suppression pool water. Each suppression pool section will contain redundant vacuum breakers such that when long term condensation in the drywell and the drywell cooling system causes drywell pressure to be lower than the suppression chamber pressure, water will not be sucked upwards through the downcomers. This also has the effect of returning some of the non-condensables back to the drywell from the suppression chambers.

In this embodiment, the suppression chambers communicate hydraulically, but should be separated by physical barriers. Hydraulic communication through ports can allow for even cooling distribution between the various sectors but can preclude a positive feedback and amplification of the hydraulic forces applied to the suppression chamber walls.

In this embodiment, the lower regions of each suppression chamber can be connected to the reactor vessel feedwater line but isolated by a double isolation valve system. With this arrangement, post-blowdown, the suppression chamber water can also act as core flood water to augment the core flood tank contributions. This is not arranged passively due to the need to protect against the anticipated transient without scram (ATWS) during isolated conditions.

In this embodiment, the passive decay heat removal system relies on being able to reduce reactor pressure to a pressure that is equalized with the core flood tanks. This can be accomplished with blowdown valves attached to the main steam lines that discharge to the suppression chambers through spargers such that the energy stored in the reactor coolant can be dissipated in the suppression chamber water. The blowdown valves are only initiated if the reactor vessel has been isolated and the water level continues to drop. A system with electric and hydraulic separation using a one-out-of-two-twice logic assures that no single failure will either cause an inadvertent actuation or preclude a needed actuation. The blowdown valves can be made to be totally passive devices that relieve against spring pressure, and once opened, will remain open.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

1. A proliferation-resistant nuclear reactor comprising:
a plurality of spherically-shaped micro-fuel elements (MFE), each comprising a MFE core having one or more fuel kernels, a buffer external to the fuel kernels, and one or more coatings external to the MFE core providing corrosion resistance, erosion resistance, fission product containment, or a combination thereof, wherein the MFEs are not suspended in a solid material, wherein at least one of the coatings prevents the coolant from breaching the MFE core, and wherein each MFE is sized such that its thermal delay time is less than its accident time; and
a reactor core containing at least a portion of the plurality of MFEs, wherein the reactor core is configured for cross-flow of a coolant.

2. The nuclear reactor as recited in claim 1, wherein the nuclear reactor is permanently closed throughout its lifetime.

3. The nuclear reactor as recited in claim 1, wherein a pressure vessel containing the reactor core further comprises a first volume for fresh micro fuel elements and a second volume for spent micro fuel elements, the pressure vessel storing sufficient fresh micro fuel elements for continuous operation during the entire lifetime of the nuclear reactor.

4. The nuclear reactor as recited in claim 3, further comprising means for in-vessel refueling, fuel recycling, or a combination thereof.

5. The nuclear reactor as recited in claim 1, wherein the thermal delay time is at least ten times shorter in duration than the accident time.

6. The nuclear reactor as recited in claim 1, wherein the micro fuel elements have a diameter greater than or equal to approximately 1 mm.

7. The nuclear reactor as recited in claim 1, wherein the micro fuel elements have a diameter less than or equal to approximately 10 mm.

8. The nuclear reactor as recited in claim 1, wherein the micro fuel element further comprises a burnable absorber external to the kernel.

9. The nuclear reactor as recited in claim 1, wherein one or more of the coatings comprises a metal-ceramic composite.

10. The nuclear reactor as recited in claim 9, wherein the metal-ceramic composite comprises a material selected from the group of nanolayered nitride hard coatings consisting of TiN, NbN, CrN, ZrN and combinations thereof.

11. The nuclear reactor as recited in claim 1, wherein one or more of the fuel kernels comprises a fuel kernel material having an element selected from the group consisting of uranium, thorium, plutonium, actinides, actinide-containing compounds, and combinations thereof.

12. The nuclear reactor as recited in claim 11, wherein the fuel kernel material is selected from the group consisting of oxides, nitrides, carbides, metals, and combinations thereof of said element.

13. The nuclear reactor as recited in claim 1, wherein the micro fuel elements are less than approximately 20% enriched.

14. The nuclear reactor as recited in claim 1, wherein the fresh micro fuel elements comprise between approximately 8% and approximately 12% U²³⁵.

15. The nuclear reactor as recited in claim 1, wherein the reactor core comprises at least one constrained bed of the micro fuel elements.

16. The nuclear reactor as recited in claim 15, wherein the reactor core comprises a plurality of reaction zones, one or more coolant source zones, and one or more coolant collection zones arranged in a concentric cylindrical structure.

17. The nuclear reactor as recited in claim 16, wherein reaction zones are separated by coolant source zones or coolant collection zones.

18. The nuclear reactor as recited in claim 1, wherein the reactor core does not contain materials that will react to produce hydrogen.

19. The nuclear reactor as recited in claim 4, wherein said means for in-vessel refueling, fuel recycling, or a combination thereof comprises an actuator to move the micro fuel elements through the reactor core.

20. The nuclear reactor as recited in claim 19, wherein the actuator is selected from the group of devices consisting of a piston, fluid jets, an engineered overlayer, and combinations thereof.

21. The nuclear reactor as recited in claim 1, wherein the coolant comprises a fluid selected from the group consisting of water, gas, or liquid metal.

22. The nuclear reactor as recited in claim 1, wherein the reactor core comprises a plurality of reaction zones.

23. The nuclear reactor as recited in claim 1, wherein the nuclear reactor is selected from the group consisting of boiling water reactors, pressurized water reactors, gas reactors, and supercritical water reactors.

24. The nuclear reactor as recited in claim 1, wherein the pressure vessel is located below ground and is not housed within an above-ground containment building.

25. The nuclear reactor as recited in claim 1, further comprising at least one spent-fuel discharge conduit attached to the second volume, wherein said conduit allows for discharge of spent micro fuel elements after the end of the nuclear reactor's lifetime.

26. The nuclear reactor as recited in claim 1, further comprising one or more in-vessel control rods arranged for insertion into the reactor core by a drive device.

27. The nuclear reactor as recited in claim 26, wherein the control rods extend through a column of MFEs containing sufficient MFEs for the entire operational life of the nuclear reactor.

28. The nuclear reactor as recited in claim 1, further comprising a coolant flow control device located in the reactor core.

29. The nuclear reactor as recited in claim 28, wherein the coolant flow control device comprises a stationary inner nozzle sheet, a rotating outer nozzle sheet, a stationary track guiding the rotation of the outer nozzle sheet, and a worm gear engaging the outer nozzle sheet.
